(19) United States
(12) Patent Application Publication
(10) Pub. No.: US 2013/0335564 A1
(43) Pub. Date: Dec. 19, 2013

(54) System with Article Surveillance Device, Article Surveillance Device and Method for Displaying Configuration Information

(71) Applicant: Remon Jan Bernardus Theodorus Spekreijse, Tubbergen (NL)

(72) Inventor: Remon Jan Bernardus Theodorus Spekreijse, Tubbergen (NL)

(73) Assignee: Cross Point B.V., Emmen (NL)

(21) Appl. No.: 14/001,170

(22) PCT Filed: Feb. 24, 2012
(86) PCT No.: PCT/NL2012/050112

§ 371 Date: Aug. 22, 2013

(30) Foreign Application Priority Data
Feb. 24, 2011 (NL) 1038605
Jun. 30, 2011 (NL) 2007029

(51) Int. Cl. H04N 7/18

(52) U.S. Cl. CPC H04N 7/18
USPC 348/143

(57) ABSTRACT

The present invention relates to a system with article surveillance device and method for displaying configuration information. The system comprises: at least one article surveillance device; a server which is connected via a communication connection to the at least one article surveillance device and which is adapted to store information concerning the configuration of the article surveillance device; and a display component for displaying the configuration information stored on the server.

The invention relates to a system comprising at least one article surveillance device. Such article surveillance devices, such as electronic article surveillance devices (EAS), cash registers and customer counters, serve to monitor merchandise, for instance in a shop. For this purpose separate articles can for instance be monitored, for instance by means of detectable labels attached to the merchandise, the movements of customers can be tracked, for instance by customer counters, and purchased products can be recorded, for instance by means of a cash register.

Diverse article surveillance devices are known in practice. For setting of such devices, maintenance and remedying of possible malfunctions the user of such a system is dependent on a specialist technician. In the case of a problem this technician has to go to the location in order to remedy said problem.

This has the drawback that the technician, even for relatively simple cases, must travel to the shop in question. This takes some time, during which the problem will continue to persist for the retailer. In addition, this entails considerable cost.

An object of the invention is to obviate the above stated problems and to provide a system comprising at least one article surveillance device which can be remotely maintained.

This object is achieved with the system according to the invention, comprising:
at least one article surveillance device with a transmitter and/or receiver;
a server which is connected via a communication connection to the at least one article surveillance device and which is adapted to store information concerning the configuration of the article surveillance device; and
a display component for displaying the configuration information stored on the server.

The server can store configuration information, for instance configuration information which has been sent to the server via the communication connection from the at least one article surveillance device or otherwise inputted. This achieves that the configuration of the at least one article surveillance device can be remotely retrieved and/or displayed. An authorized person, such as the technician or the shop owner, can hereby obtain information remotely, i.e. via the server, about the configuration of the at least one article surveillance device.

The display component is for instance adapted to display as text the configuration information stored on the server. They display component preferably comprises a visualization component adapted to visualize the configuration information.

It is found in practice that in many cases a malfunction or false alarm can be attributed to the configuration of an article surveillance device in relation to other objects and/or passageways. This relates particularly to the configuration relative to equipment, such as other article surveillance devices. In some cases the configuration relative to for instance walls or shop displays is also a contributing factor. The orientation of the devices relative to each other may also be important.

Such a malfunction can be identified quickly at the location, although this is not possible remotely. By means of the system according to the invention a technician obtains the same, or in any case substantially the same information in respect of the configuration of the article surveillance device as if he/she were at the location. A tool is therefore hereby obtained for remotely determining problems which can be attributed to the configuration of the article surveillance device. This is particularly important for tracing interference sources. The display component will here display possible interference sources.

The system is for instance adapted to recognize interference sources on the basis of the configuration information, and the display component is optionally adapted to display the interference sources.

Examples of article surveillance devices are electronic article surveillance systems (EAS), such as systems for the detection of acoustic-magnetic (AM) labels or radiofrequency (RF) labels, including identification labels (RFIDs), people counters (also referred to as customer counters) and alarm systems. Alternatively or additionally, the system comprises a camera system, which is not generally deemed an article surveillance device according to the invention. The article surveillance systems are preferably stationary systems.

The article surveillance system comprises for instance an active transmitter.

In a currently preferred embodiment of the system according to the invention the communication connection between the article surveillance device and the server is realized by a controller on the side of the article surveillance device. A plurality of article surveillance devices in one shop are for instance connected to the controller, which is also located in the shop, and the controller is connected to the server adapted to store configuration information. The controller preferably also stores configuration information and synchronizes this information with the server. The controller can preferably also be directly accessed by the technician, for instance during installation of the surveillance devices. The controller can for instance be accessed wirelessly, or the controller is provided with an input device or input connection. In addition, the controller can be adapted to communicate additional information to the server for storage thereon, such as customer count information, alarm information, malfunction information and signal strength. Alternatively, the controller functions as server or the server functions as controller for one or more of the devices.

The configuration information comprises for instance the coordinates of the at least one article surveillance device in a predetermined coordinate system. The configuration information preferably comprises relative position information.

The communication connection can as required be a continuous connection or a non-continuous connection. The communication connection can take a wired or wireless form.

In a currently preferred embodiment the system comprises a local controller which is connected to the at least one article surveillance device and connected to the server. The communication between the at least one article surveillance device and the server takes place in this embodiment via the controller. The controller preferably also stores the configuration information and the controller synchronizes this information with the server.

The server also stores for instance other information relating to the at least one article surveillance device, such as information about the location and/or address of the shop in which the device has been installed. The location and/or the address of the shop is for instance determined on the basis of GPS, an IP address or by manual input of data.

In a preferred embodiment according to the invention the configuration information comprises information relating to the configuration of the article surveillance device in relation to objects and/or passageways.

The configuration information comprises for instance information concerning the configuration of objects which can affect the functioning of the article surveillance device. Such interference sources are for instance lamps, lifts or other article surveillance devices.

The configuration information comprises for instance information relating to the configuration of the article surveillance device in relation to a shop display. It occurs in practice that a retailer places products provided with detection labels in the shop display. Such detection labels can be detected by an article surveillance device in the vicinity of the shop display. This can result in a false alarm. When a retailer observes that an article surveillance device regularly generates a false alarm, and subsequently contacts a technician to remedy the problem, the technician can quickly ascertain by means of the configuration information that the device concerned is situated in the vicinity of a shop display. The technician can then request the retailer to check the shop display for the presence of detection labels. This can avoid an unnecessary journey by the technician to the shop in question.

In a preferred embodiment according to the invention the system comprises at least two article surveillance devices connected via a communication connection to the server, wherein the server is adapted to store information relating to the configuration of the at least two article surveillance devices in relation to each other.

Two or more article surveillance devices located in the vicinity of each other can cause each other to malfunction or have other adverse effects on each other. By means of the invention a technician, or the retailer or other authorized person, has at his/her disposal information relating to the configuration of the at least two article surveillance devices in relation to each other, including for instance arrangement, orientation and/or distance. In the case of a malfunction of several of the article surveillance devices the relative configuration can hereby be taken into account in the analysis of the problem without the physical presence of the technician being necessary for this purpose in the relevant shop.

It is also possible here to envisage interference by another article surveillance device of a nearby shop. The configuration of the article surveillance device relative to the nearby shop provides the technician with'information in this respect.

The configuration information comprises for instance the arrangement of the article surveillance devices, objects and/or passageways, i.e. on which side the different objects are located relative to each other (to the left, right, above, below, in front or behind).

The configuration information comprises for instance information relating to the relative distance between the at least one article surveillance device and other objects or article surveillance devices.

The configuration information comprises for instance the coordinates of the at least one device and the other objects or article surveillance devices in a determined coordinate system. Such information comprises both distance and arrangement information.

The configuration information comprises for instance information relating to the orientation of the article surveillance devices, i.e. information about which sides of the devices face toward or away from each other.

In a further preferred embodiment according to the invention the system comprises means for determining, preferably automatically, the relative configuration of the article surveillance devices.

Providing these means achieves that the configuration of the article surveillance devices is determined automatically.

One of the article surveillance devices comprises for instance a receiver and a processing unit connected to the receiver, wherein the receiver can receive signals from other article surveillance devices and the processing unit can determine on the basis of these signals the distance or relative position/arrangement or orientation in relation to the respective article surveillance device. In another example the information is entered by the technician. The server and/or the controller for instance comprise the processing unit. The invention relates particularly to a system comprising at least two article surveillance devices and means for determining the relative configuration of the article surveillance devices.

Alternatively, the server comprises a processing unit and the devices are adapted to communicate the measured signal strengths to the server. The server also has available information relating to the power emitted by the different devices, for instance on the basis of a setting. The processing unit determines for instance the distance between the different devices on the basis of the measured signal strengths and the adjusted powers.

The means for determining the relative configuration preferably comprise a transmitter and/or receiver. In preference the transmitter and/or receiver is respectively a transmitter and/or receiver for optical, preferably infrared signals.

Optical signals in particular have the advantage that they can be directed, whereby they are highly suitable for determining the relative configuration.

An EAS already comprising a transmitter and/or receiver for the detection of labels or a customer counter already comprising a transmitter and/or receiver for counting passing customers is for instance provided with an additional transmitter and/or receiver for determining the relative position, or the EAS or customer counter is adjusted such that the transmitter and/or receiver performs both its original function and the function of determining the relative position.

The information is preferably updated automatically by determining the relative configuration automatically when the configuration of the article surveillance devices is changed. The means for determining the relative position comprise for instance a registration component for registration at the controller and/or the server, wherein the system is adapted, when an article surveillance device is registered, to determine the relative configuration of article surveillance devices of the system. This has the advantage that devices can easily be added to the system, wherein the relative configuration is updated. In addition, the configuration information is updated when an article surveillance device is enabled or disabled, this having the advantage that this information is up-to-date. Information relating to registered and non-registered devices is preferably displayed by the display component. The at least one article surveillance device comprises for instance the registration component.

The means for determining the relative configuration preferably comprise means for determining the distance and/or the relative arrangement and/or orientation. Arrangement is understood to mean the direction in which the one device faces relative to the other.

Each of at least two article surveillance devices comprises for instance a transmitter and/or receiver, and the means for determining the relative configuration are adapted to cause the one or more transmitters to transmit a signal, preferably successively, and to determine the relative configuration of the devices on the basis of the signal received by the receivers.

The system comprises for instance three devices, each comprising a transmitter and receiver. The system comprises at least one controller adapted to cause the three transmitters to successively transmit a signal. The signal from the first device is received by both other devices. The signal from the second and third device respectively is received only by the first device. On the basis hereof the controller determines that the first device is disposed between the second and third device. These are for instance one customer counter and two EAS systems.

At least one of the article surveillance devices preferably comprises at least two transmitters and/or receivers arranged at separate positions on the device. On the basis of the signal received by a receiver of such a device and/or by receiving a signal coming from a transmitter of such a device the means for establishing the relative position determine the orientation of this device relative to the respective transmitting or receiving device.

This is particularly important when the orientation of article surveillance devices affects the operation of the devices. The orientation can for instance be important in the case of EAS antennas, because the orientation of the antenna determines the orientation of the interrogation field generated by the antenna. If two or more EAS antennas are disposed in incorrect orientation, for instance rotated relative to their design orientation, the generated fields can go into antiphase, or in any case counteract each other, which does not enhance detection. By means of the invention the orientation of article surveillance devices relative to each other can be automatically determined, and an erroneous configuration can therefore be remotely detected.

The at least one device is for instance provided with an infrared transmitter and receiver. Two devices determine their relative position/arrangement on the basis of one or more transmitted infrared patterns.

In an advantageous embodiment the system comprises a processing unit which defines clusters of devices, preferably on the basis of the configuration information of different devices. Surveillance devices will in practice be disposed in grouped manner at passageways, such as entrances and exits. By for instance determining which devices are disposed within a certain distance of each other, it is possible to automatically ascertain that these devices are all disposed at the same passageway.

Alternatively or additionally, the processing unit is adapted to determine, on the basis of the detection by a first article surveillance device of signals coming from a second article surveillance device, whether these devices belong to the same cluster. A determination of distance can then be dispensed with. The unit is for instance adapted to group a first device which receives a signal from a second device in the same cluster, wherein devices which do not receive each other's signals are grouped in another cluster. The processing unit is for instance accommodated in the above stated controller and/or server.

The devices are for instance each equipped with a transmitter and/or receiver, and the system is adapted to cause the transmitters to transmit a signal, preferably successively, after which the system determines on the basis of the signal received by the receivers which devices are located within each other's signal range, i.e. belong to the same cluster.

The devices are for instance equipped with an optical, preferably infrared transmitter and/or receiver, preferably with both an optical transmitter and an optical receiver.

The system preferably further comprises a processing unit which is adapted to define a number of pathways on the basis of the number of clusters of article surveillance devices. The number of pathways will generally correspond to the number of clusters, and the processing unit will equate the number of pathways to the number of clusters.

The display component is preferably further adapted to display, and preferably visualize, the pathways. Information concerning a pathway, such as information about the number of passing customers coming from a customer counter, is for instance displayed or visualized.

A processing unit of the system is for instance adapted to determine clusters of devices as well as relative arrangement, relative distance or orientation.

The system preferably comprises at least one first article surveillance device with a transmitter, at least one second article surveillance device with a receiver and a processing unit which is adapted to determine, on the basis of an interruption of the reception by the receiver of a signal sent by the transmitter, that there is an obstruction present between the first and second article surveillance devices. The obstruction is preferably displayed by means of the display component.

The obstruction is for instance displayed visually, for instance as a block between images of the respective article surveillance devices.

The processing unit is preferably adapted to determine that an obstruction is present on the basis of an interruption persisting for a predetermined time duration, for instance 30 seconds or longer. This prevents too sensitive an obstruction detection.

The display component is preferably a 3-D visualization component.

By visualizing the configuration information in a 3-D display the situation in which the technician is physically present in the shop is approached as closely as possible. Alternatively or additionally, the display component comprises a 2-D visualization component in which the configuration information is shown in a top view or side view.

The display component comprises for instance a video component for displaying images from a security camera.

The server preferably comprises a log-in component and a rights administration component.

By means of the log-in component a user can log onto the server to thus gain access to the information stored thereon, such as the configuration information, obstruction information, signal strengths and count information. This access is gained only when the rights administration component identifies that the user is indeed authorized to obtain access to the relevant information.

By logging onto the server the technician for instance gains access to the data relating to article surveillance devices of all shops administered by him/her. Alternatively or additionally, a retailer can gain access to the information or a part of the information stored on the server relating to the article surveillance devices, such as EAS systems or customer counters, in his/her own shop. The retailer or the technician for instance logs onto the server making use of a desktop computer, laptop, tablet or smart phone. The retailer also gains access for instance to count information or an obstruction of an article surveillance device.

In a preferred embodiment of the system according to the invention the at least one article surveillance device is adapted to communicate information concerning its settings and/or measurement data to the server via the communication connection, and the server is adapted to store this information and the display component is adapted to display this information.

The information relating to the settings of the article surveillance device and/or measurement data comprises for instance power consumption, alarm status and/or alarm history, visitor numbers, noise levels, configuration information, type number and frequency of a transmitted signal.

Communicating the information to the server achieves that the relevant information can be displayed at the associated device by means of the display component. A better insight is hereby obtained into the situation of the different article surveillance devices.

A cash register system is for instance adapted to communicate information concerning sold products to the server.

In another example a detection post for RFID labels is adapted to communicate data concerning identified products to the server. Because the location of the detection post is also stored on the server, this provides information about where the product is located in the shop.

In an embodiment according to the invention the information comprises malfunction information and/or alarm information.

This information is particularly relevant for detecting a so-called tag in the field. This relates to the unintended presence of tags, also referred to as detection labels or simply labels, in the detection field of an article surveillance device, for instance when labels are present in a shop display in the vicinity of an article surveillance device. A false alarm can hereby be generated. Because alarm information is communicated to the server, a technician can observe that a determined article surveillance device generates an alarm relatively often, this pointing to the possibility of a tag in the field. In the case it is found on the basis of the configuration information that the article surveillance device concerned is located in the vicinity of for instance a shop display, rack of clothing or the like, the technician concludes that there is a strong possibility of a tag in the field. A report of a possible tag in the field is preferably made automatically.

In a preferred embodiment according to the invention the information is up-to-date information.

The configuration information and/or the information concerning the settings of the article surveillance device and/or the measurement data is preferably up-to-date information. A current picture is hereby obtained of the status of the different article surveillance devices in combination with their relative configuration. Such up-to-date information makes it possible for the technician to take proactive measures, i.e. a malfunction can be detected at an early stage even before a retailer has sought contact with the technician.

In a preferred embodiment of the system according to the invention the server comprises a setting component for modifying the settings of the at least one article surveillance device connected to the server.

Providing a setting component achieves that the settings of the article surveillance device can be modified remotely and/or per arrangement. A technician will for instance carry out a determined modification remotely on the basis of his/her analysis of the data relating to the article surveillance device. Alternatively, determined modifications are realized automatically, for instance in the case of a frequently occurring problem such as interference from a nearby article surveillance device by too'great a power being emitted.

The automatic modification is preferably realized as follows. An analysis component of the server has available the information concerning the mutual distance between two article surveillance devices, the power they emit and the type of device. On the basis of the type number a search is made in a database as to what the maximum power is at the known distance. If the set power exceeds the maximum power, the setting is modified.

In a further embodiment the server comprises a copying component for copying the settings of a first article surveillance device to the settings of a second article surveillance device.

This achieves that determined preferred settings can be easily applied to a plurality of devices. A technician can for instance copy all settings or a part of the settings of one article surveillance device in a specific shop to other article surveillance devices in this shop.

A technician can for instance also copy the settings of the article surveillance devices in a specific shop to the settings of article surveillance devices in another shop, this being advantageous for instance in the case of a chain of shops.

The server for instance comprises the copying component.

Notification settings, such as alarm sounds, settings of lamps and external I/Os, are for instance stored on the server. These stored settings can then be applied on all devices within one shop, or even on all devices of a chain of shops consisting of a plurality of shops.

The copying component provides the option of making a backup of settings and subsequent restoring thereof on the basis of the backup.

In an embodiment according to the invention the at least one article surveillance device is adapted to initiate a connection to the server via the communication connection. The system alternatively comprises a controller connected to the at least one device and adapted to make a connection to the server via the communication connection.

This has the advantage that a simple installation is realized. The device makes a connection to the server, at a pre-known address, instead of the server making connection to the device, the address of which is not by definition pre-known.

An additional advantage is that a safe connection is realized. The device cannot be accessed externally and can only make connection to the server assigned thereto. The server then administers the rights to access the device.

The article surveillance device and/or controller is for instance connected with an ethernet cable to the internet, after which it automatically registers with the server.

This achieves a simple installation of the device. The device need only be connected to internet, for instance using an ethernet cable, after which a safe connection is automatically made. No manual settings are necessary on the user side to configure the connection, i.e. it is a “zero-config” connection.

After initializing of the connection by the article surveillance device and/or controller it is possible to access the article surveillance device via the server. The user for instance logs onto the server, after which this latter effects a connection between the logged-on user and the article surveillance device.

A user logs onto the server for instance via an application on a PC, laptop, tablet or smart phone, and the server then communicates data to this application. This has the advantage, compared for instance to access via a web page, that detailed visualizations are possible.

This achieves that a simple installation of the article surveillance device is provided and that further article surveillance devices can easily be added to the system.

Settings for a mail server are preferably also automatically made when establishing the connections. Such a mail server is for instance used for sending reports or notifications via e-mail to the technician or end user. Setting of a mail server normally requires several operations. In the system according to the invention this is realized automatically, for instance in that the central server comprises a mail server application.

In a currently preferred embodiment a controller connected to at least one article surveillance device initiates a connection to the server so that a connection between the server and the article surveillance device exists via the controller.

An alternative system according to the invention comprises at least one article surveillance device and a server connected via a communication connection to the at least one article surveillance device, wherein the article surveillance device is adapted to initiate a connection to the server via the communication connection. A display component as specified above is optionally present herein.

In a currently preferred embodiment the system according to the invention comprises a controller connected to the at least one article surveillance device so that the article surveillance devices communicate with the server via the controller. It is noted that features described above for the server can be provided, alternatively or additionally, in the controller.

The invention also relates to an article surveillance device evidently intended for use in the system as described above.

The article surveillance device comprises for instance a communication component for connecting the device to the server.

The article surveillance device preferably comprises means for determining the configuration in relation to at least one other article surveillance device.

The means for determining the configuration in relation to at least one other article surveillance device preferably comprise a transmitter and/or receiver, preferably an optical transmitter and/or receiver, more preferably an infrared transmitter and/or receiver.

The invention also relates to a method for displaying information relating to the configuration of at least one article surveillance device making use of the system as described above.

The article surveillance device and the method according to the invention have the same advantages and effects as described above in respect of the system.

In a preferred embodiment of the method according to the invention the method comprises of automatically determining the relative configuration of at least two article surveillance devices.

This achieves that the configuration information can be generated automatically.

The invention also relates to a computer program which, when run on a computer, performs the method as described above, and an information carrier comprising such a computer program.

Further advantages, features and details of the invention are elucidated on the basis of preferred embodiments thereof, wherein reference is made to the accompanying figures.

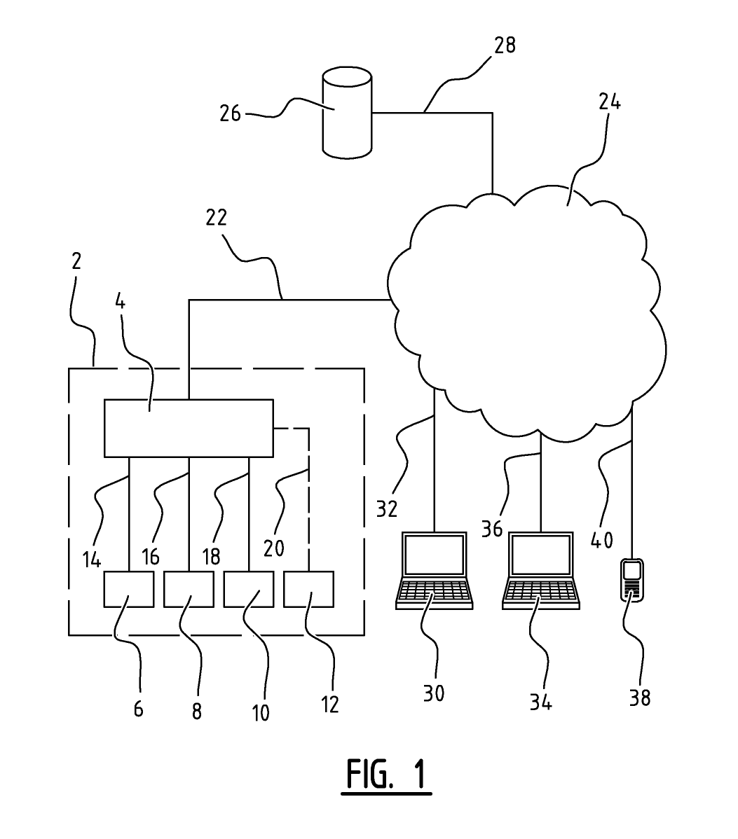

FIG. 1 shows a schematic representation of a system according to the invention; and

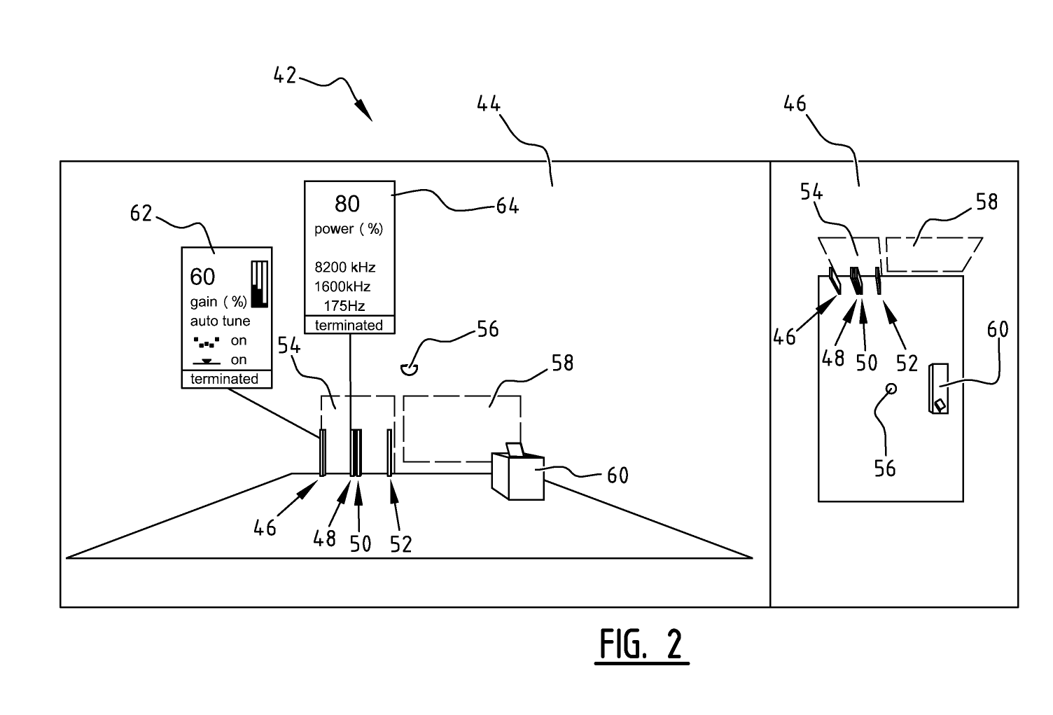

FIG. 2 shows an example of what a visualization component in the system according to the invention can display.

Present in a shop is a local article surveillance system 2. Local system 2 comprises a local controller 4 which is connected to article surveillance devices 6, 8, 10, 12. Article surveillance devices 6, 8 and 10 are connected to controller 4 by means of communication lines 14, 16, 18. Article surveillance device 12 is connected by means of a wireless connection 20 to local controller 4.

Controller 4 is connected by means of connection 22 to the internet 24. Situated at another location is a server 26 which is connected via connection 28 to the internet 24. In addition, a computer 30 of a technician is connected by means of connection 32 to the internet. A computer 34 of a shop owner is also connected to internet 24 via connection 36. Finally, smart phone 38 is connected via connection 40 to internet 24.

In the example the devices 6, 8 and 10 are posts of an EAS system. Device 12 is a people counter.

Devices 6, 8 and 10 can determine their mutual distance by measuring the intensity of the signals transmitted by the other devices. Alternatively or additionally, the devices determine their orientation and/or arrangement in relation to each other. This information is communicated via connections 14, 16, 18 to controller 4. People counter 12 communicates the number of counted people to local server 4 via wireless connection 20. Alternatively, connections 14, 16 and/or 18 are also wireless. Additionally or alternatively, devices 6, 8, 10 and 12 determine their mutual distance, orientation and/or arrangement.

Controller 4 makes a connection to server 26 via internet 24. When the connection has been established, controller 4 communicates the configuration information of devices 6, 8 and 10 and the count information of people counter 12 and general information concerning the shop in which controller 4 is placed, such as location, address and so on, to server 26.

Server 26 can optionally supplement this information with information which is available internally or on internet 24. This is for instance information concerning the weather conditions at the relevant shop, which can be retrieved on the basis of the location, or information associated with the type numbers of the different devices, which can be consulted via a database.

Using his/her computer 30 a technician logs onto server 26 internet 24. Once the technician has logged on correctly, server 26 presents a list with different shops for which the technician has rights to view the settings, including the system in shop 2.

The shop owner can also make a connection to server 26 using his/her computer 34. The shop owner will generally have fewer rights than the technician. The shop owner will for instance thus not be able to modify the settings of the various devices 6, 8, 10, 12.

Computers 30 and 34 comprise a visualization component in the form of software. The configuration information is obtained following correct log-on to server 26 and is visualized on the respective computer 30, 34.

An example of a visualization is shown in FIG. 2. Display or screen shot 42 comprises a 3-D portion 44 and a portion 46 with a perspective top view.

The detection posts 46, 48, 50, 52 and the associated passageway 54 are visualized in display 42. The distance between the detection posts is shown to scale on the basis of the configuration information stored on server 26.

In addition, security camera 56, shop display 58 and cash register 60 are visualized.

The current status of detection posts 46 and 48 is displayed in the form of information boxes 62 and 64. Among other information, the actual power consumption and the frequency applied are shown herein. Information boxes for the different article surveillance devices 46, 48, 50, 52, 56 can be retrieved or concealed by clicking or double-clicking on the respective device.

If post 46 does not receive a signal from post 48 for 30 seconds, the system according to the embodiment concludes that an obstruction is present, and this is shown in display 42 as a block or cross between these posts.

The present invention is by no means limited to the above described preferred embodiments thereof. The rights sought are defined by the following claims, within the scope of which many modifications are possible.

1. A system, comprising:
at least one article surveillance device with at least one of a transmitter or receiver;
a server which is connected via a communication connection to the at least one article surveillance device and which is adapted to store configuration information related to the article surveillance device; and
a display component for displaying the configuration information stored on the server.

2. The system of claim 1, wherein the configuration information comprises information relating to the configuration of the article surveillance device in relation to at least one object or passageway.

3. The system of claim 1, further comprising at least two article surveillance devices connected via a communication connection to the server, wherein the server is adapted to store information relating to the configuration of the at least two article surveillance devices in relation to each other.

4. The system of claim 3, further comprising means for determining the relative configuration of the two article surveillance devices.

5. The system of claim 1, wherein the display component is a 3-D visualization component.

6. The system of claim 1, wherein the server comprises a log-in component and a rights administration component.

7. The system of claim 1, wherein the at least one article surveillance device is adapted to communicate information related to at least one of settings or measurement data to the server via the communication connection, and the server is adapted to store the information related to the at least one of settings or measurement data, and further wherein the display component is adapted to display this information.

8. The system of claim 7, wherein the information related to the at least one of settings or measurement data comprises one or more of malfunction information or alarm information.

9. The system of claim 1, wherein the configuration information is up-to-date information.

10. The system of claim 1, wherein the server comprises a setting component for modifying one or more settings of the at least one article surveillance device connected to the server.

11. The system of claim 10, wherein the server comprises a copying component for copying one or more settings of a first article surveillance device to one or more settings of a second article surveillance device.

12. The system of claim 1, wherein the at least one article surveillance device is adapted to initiate a connection to the server via the communication connection.

13. An article surveillance device, comprising:
a receiver; and
a processing unit operatively coupled to the receiver;
wherein the receiver is configured to receive signals from at least one other article surveillance device and the processing unit is configured to determine one or more of the distance, relative position, or orientation of the at least one other article surveillance device based on the received signals.

14. A method, comprising:
connecting a server via a communication connection to at least one article surveillance device;
storing, on the server, configuration information related to the article surveillance device; and
displaying, using a display component, the configuration information stored on the server.

15. The method of claim 14, further comprising automatically determining the relative configuration of at least two article surveillance devices.

16. A computer program product encoded on a non-transitory computer-readable storage medium for enabling one or more processors to perform a method, the computer program product comprising:
software instructions stored on the computer readable medium for enabling one or more processors to perform predetermined operations comprising:
connecting a server via a communication connection to at least one article surveillance device;
storing, on the server, configuration information related to the article surveillance device; and
displaying, using a display component, the configuration information stored on the server.

17. Information carrier comprising a computer program product as claimed in claim 16.

18. The computer program product of claim 16, wherein the software instructions stored on the computer readable medium for enabling one or more processors to perform predetermined operations further comprising automatically determining the relative configuration of at least two article surveillance devices.

19. The information carrier of claim 17, wherein the software instructions stored on the computer readable medium for enabling one or more processors to perform predetermined operations further comprising automatically determining the relative configuration of at least two article surveillance devices.

20. The computer program product of claim 16, wherein the display component is a 3-D visualization component.
